(19) United States
(12) Patent Application Publication
(10) Pub. No.: US 2009/0145490 A1
(43) Pub. Date: Jun. 11, 2009

(54) Water conservation / hot water recirculation system utilizing timer and demand method

(76) Inventor: Donald Gregory Kershisnik, Northridge, CA (US)

Correspondence Address: Donald, Gregory Kershisnik, 8915 Balcom Ave, Northridge, CA, 91325, US

(21) Appl. No.: 12/221,767

(22) Filed: Aug. 6, 2008

Related U.S. Application Data
(60) Provisional application No. 60/954,398, filed on Aug. 7, 2007.

(51) Int. Cl. F16L 53/00

(52) U.S. Cl. 137/334

(57) ABSTRACT

In most homes today, when a person turns on a hot water faucet, he or she must wait for residual cold water to flow out of the hot water pipe as hot water travels from the water heater to the faucet. That residual cold water typically goes down the drain. In some buildings, recirculating hot water systems keep hot water flowing in a loop, thereby making hot water immediately available and eliminating the waste of residual hot water, but these systems waste energy from thermal radiation in the hot water pipes at times when no hot water is being utilized. The invention conserves both water and energy by controlling the recirculation of residual cold water by means of momentary activation of any hot water faucet, and also by programmed time-of-day intervals, whereupon the pump replaces the residual cold water with hot water and recirculates the residual cold water, and then turns off so as to avoid energy waste from running hot water through the loop at times it is not needed. The invention provides for fast installation of the pump, detector, and controller on the hot water outlet side of the water heater. It can be used in buildings that have separate hot water return pipes, and it can also be used in configurations where existing cold water pipes are used for the return of hot water.

### 1. CROSS-REFERENCE TO RELATED APPLICATION

This application refers back to Provisional Patent Application No. 60/954,998 filed on Aug. 7, 2007 by the same inventor, and the inventor requests the Aug. 7, 2007 filing date for purposes of the effectiveness of the non-provisional patent applied for herein.

### 2. BACKGROUND OF THE INVENTION

In most homes and other buildings, when a person turns on the hot water faucet of a sink, tub or shower, the water initially comes out cold, and he or she must wait for a period of time for the water to get hot. During that waiting period, a substantial amount of residual cold water (that was sitting in the hot water pipes but cooled off by thermal radiation) typically flows directly into the drain and gets wasted.

Some buildings contain recirculating hot water systems wherein hot water is constantly flowing around a loop that passes within a short distance of the various hot water faucets. This eliminates most of the delay and, consequently, most of the waste of cold water down the drain. The hot water return pipe must lead from the furthest point where hot water is used back to the water heater, and a pump must be provided for circulating hot water around the loop. However, pumping hot water around the loop at all times results in a loss of energy, particularly when, during much of the day or night, no hot water is being used. The energy loss occurs from radiation of heat out of the hot water pipes.

Unless the building was originally constructed with the hot water return piping, the installation of a hot water return pipe in an existing building could be a major plumbing job requiring the opening of walls and routing of a new pipe across a significant distance. Prior art has solved this problem by utilizing existing cold water piping for the return of hot water. This requires the installation of a thermal check valve at a point in the piping that is farthest away from the water heater, and that connects the hot side to the cold side. When the water is cold, the thermal check valve opens for one-way flow to allow the still-cold residual water in the hot water pipe to flow into the cold water pipe for return to the water heater, which causes that residual cold water to be recirculated rather than going down a drain. When hot water finally reaches the thermal check valve, it closes, thereby preventing hot water from getting into the cold side and flowing out of cold-water faucets.

Prior art has addressed the manner in which the recirculation pump is turned on and off. A first approach (hereinafter called “Button Control”) provides for switches, buttons, or other electronic activation mechanism in kitchens, bathrooms and other places where people use hot water. When a person knows he or she will need hot water, he or she presses such a button, thereby activating the pump for a limited time period (e.g. for 10 minutes). After waiting for the residual cold water to be recirculated and replaced with hot water, the person turns on the hot water faucet, and hot water comes out almost immediately. Such activation mechanisms have been built into light switches in kitchens and bathrooms. The connection from the Button Control mechanism back to the pump can be either by wire or wireless, both of which have disadvantages. The wire method requires the routing of many wires in the building, from a Button Control by each hot water fixture back to the pump. The wireless method, which is generally powered by batteries at each Button Control location, is susceptible to radio interference, and might fail entirely due to loss of radio signal from locations that are physically remote from the pump or separated by concrete walls from the pump.

The second approach (hereinafter “Time-of-Day Control”) provides for automatically turning the pump on at certain times of day and turning it off the rest of the time. Time-of-Day Control has the advantage that when certain times of day are very likely to be hot-water-use times, the pump can be set to run at those times, and, at those times, hot water is immediately available at each location in the building. But Time-of-Day Control has two disadvantages. First, during the times when the pump is off, the system reverts to the old way, wherein a person must pour residual cold water down the drain while waiting for hot water. Second, during the times when the pump is running but no hot water is being used, thermal energy radiates from the hot water in the pipes and is wasted—and this energy loss is exacerbated with time-of-day settings of longer duration.

A third approach, such as that described in U.S. Pat. No. 4,936,289 (hereinafter the “Peterson Patent”), provides for activating the pump simply by opening a hot water faucet somewhere in the building. This has the advantages of Button Control, but eliminates the need for the switches or buttons where hot water is used. The Peterson Patent accomplishes this by detecting the flow of cold water through a “makeup water supply pipe” that conducts cold water from the outside (i.e. from the street) into the water heater. The disadvantage of Peterson's approach is that it implies that the detector and the pump be located in separate places, requiring two distinct installations.

### 3. BRIEF OF THE INVENTION

The invention described herein provides for a person to signal the system by momentarily turning a hot water faucet on, and then off, thereby causing residual cold water to flow down the drain for just a fraction of a second. In response to this signal, the pump starts and hot water begins circulating through the system. After an appropriate waiting period, the person then turns the hot water faucet back on, and hot water immediately arrives. Additionally, the system can be programmed for the pump to run at particular time-of-day settings, thereby combining the advantages of Peterson's approach with Time-of-Day Control.

After being activated by a person momentarily turning a hot water faucet on and off, the pump stays on for a short time limit, which should be long enough to pump hot water to the farthest point on the loop, after which the pump automatically shuts off. Thus, once activated (and assuming the person turns the hot water faucet off to prevent unnecessary waste of residual cold water), the pump delivers hot water all the way to the end of the line recirculating the residual cold water.

The invention can be used in buildings that contain separate hot water recirculation pipes. It can also be used when existing cold water pipes are used for recirculation (by means of a thermal check valve at the farthest point from the water heater).

The invention provides two alternative types of “fast installation unit.” The first combines the pump, the flow detector, and the controller all into a single “type one fast installation unit” that is installed on the hot water outlet side of the water heater. The second, which is only used in buildings where the cold water pipes are used for recirculation, combines the pump, the controller and the thermal check valve all into a single “type two fast installation unit” that is installed in the same position as the thermal check valve.

The invention differs from, and improves upon, the Peterson Patent by locating the detector on the hot side of the water heater (rather than on the cold side).

### 4. BRIEF DESCRIPTION OF THE DRAWINGS

FIG. 1 shows the invention without the “type one fast installation unit.”

FIG. 2 shows the invention with the “type one fast installation unit.”

FIG. 3 shows the invention with the “type one fast installation unit” as used in a system that utilizes cold water pipes for recirculating hot water.

### 5. DETAILED DESCRIPTION OF THE INVENTION

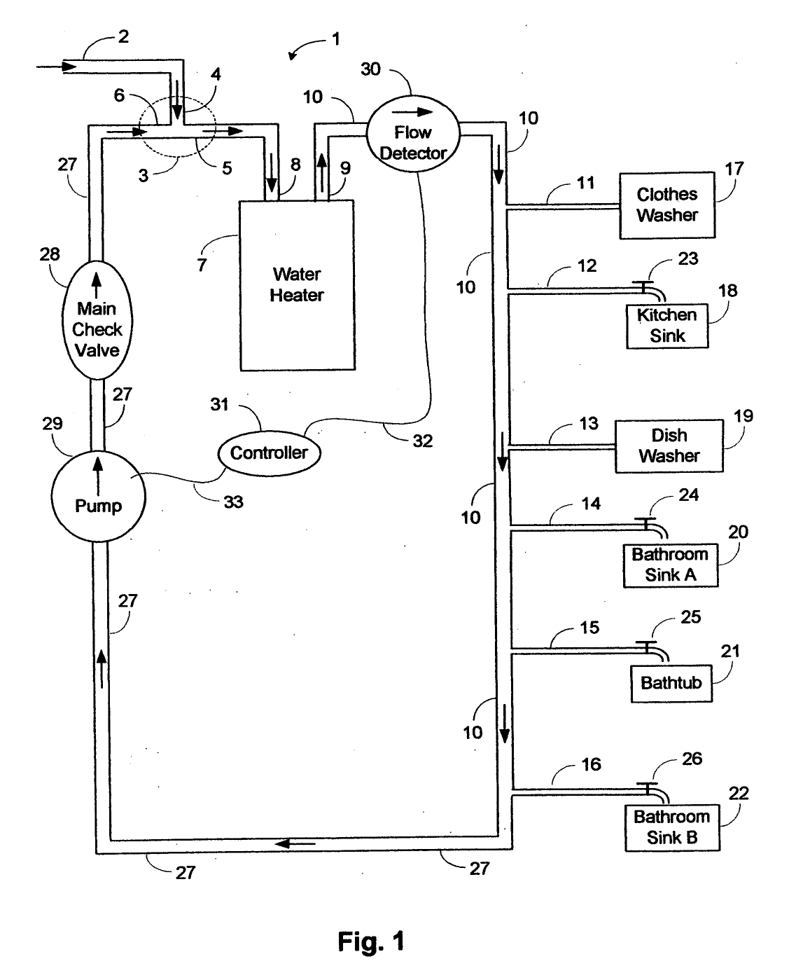

FIG. 1 shows the invention in its most general form. Cold water enters the system 1 through a source pipe 1, which connects to a main tee pipe 3. From there cold water flows out one port 5 of the main tee pipe to the inlet 8 of the water heater 7. Hot water flows out of the water heater 7 through its outlet 9 and into a hot main pipe 10, which feeds hot branch pipes 11-16 leading to various stations 17-22. The branch pipe at 11 is the nearest branch pipe to the water heater 7. Stations 17 and 19 are automatic stations. Stations 18 and 20-22 are manual stations, each having hot water faucets 23-26. Station 22 is the farthest manual station from the water heater 7. After reaching the farthest manual station 22, the hot main pipe 10 feed into a return pipe 27 which leads back to the main tee pipe 3, thereby completing the recirculation loop. A main check valve 28 is located on the return pipe 27 to prevent cold water from the source pipe 1 flowing through the return pipe 27 to the hot branch pipes 11-16, which would (without the main check valve) defeat the water heater. A pump 29 is located anywhere on the loop, and as shown in FIG. 1, is located on the return pipe 27. A flow detector 30 is located on the hot main pipe 10 at a point between the outlet 9 of the water heater 7 and the nearest branch pipe 11. A controller 31 is connected to the pump 20 and flow detector 30, respectively, by connections 32 and 33.

When the detector 30 senses the flow of water, it signals the controller 31, which activates the pump 29 in response. The controller 31 then keeps the pump 29 running for a time limit, after which it turns off the pump. The time limit is sufficient for the pump 30 to move hot water from the water heater 7 to the farthest hot branch pipe 16.

When a person momentarily turns any hot water faucet 23-26 and then immediately off, which will waste a very small amount of residual cold water, the flow detector 30 detects the momentary flow. In response thereto, the controller 31 turns on the pump 29, which pumps hot water long enough for it to reach the farthest hot branch pipe 16. After waiting an appropriate amount of time, the person then turns the hot water faucet 23-26 back on, and, after waiting very briefly for a small amount of residual cold water to drain from the affected hot branch pipe 12 and 14-16 (which is typically just few feet in length and holds a relatively small amount of water in comparison with the lengthy hot main pipe 10), hot water comes out of the faucet 23-26.

Additionally, the controller 31 provides a set of adjustable programmed-activation-times, each of which is a time-of-day interval (i.e. a start time and a stop time) during which the pump is automatically kept running, regardless of whether the flow detector 30 senses any water flow. The controller thus has two separate mechanisms for turning on the pump—by sensing hot water flow and by the time of day being in any of the programmed intervals. The pump is turned off only when neither mechanism indicates that it should be on.

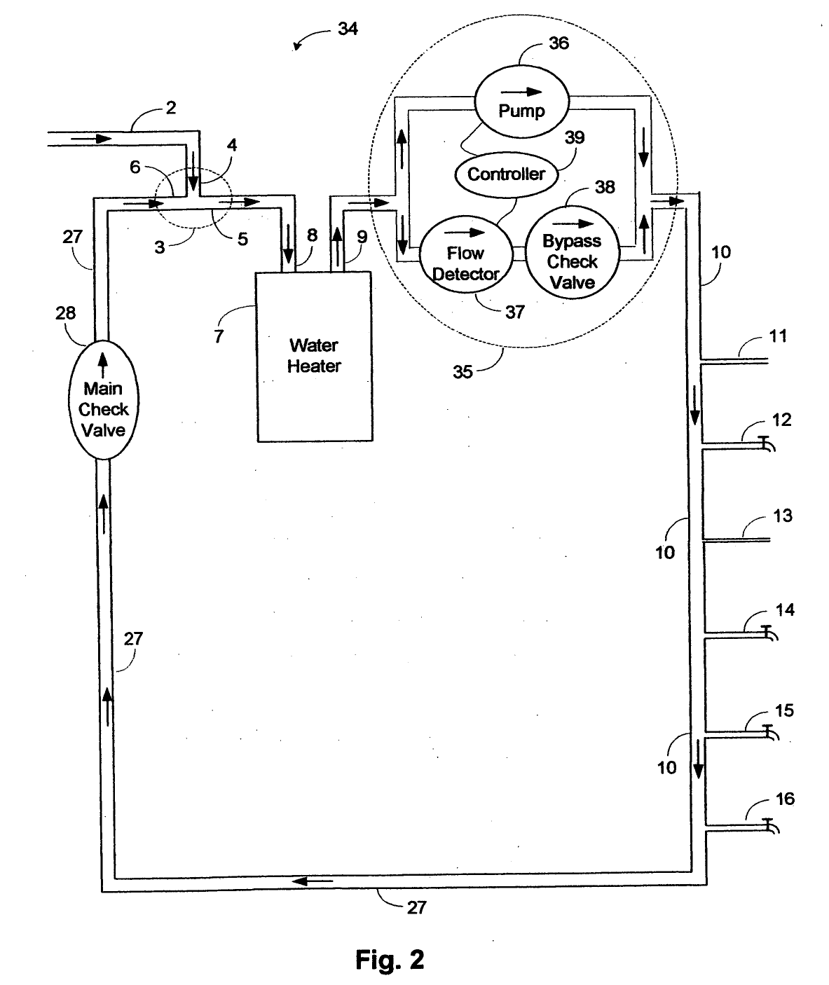

FIG. 2. shows a system 34 in the same configuration as FIG. 1, except that the pump 36, the flow detector 37, a bypass check valve 38, and the controller 39 are all integrated into a “type one fast installation unit” 35. Details of the stations and faucets shown in FIG. 1 are omitted from FIG. 2. When the pump 36 is off and a person momentarily turns any hot water faucet, that hot water flows briefly through the flow detector 37 and the bypass check valve 38. In response thereto, the controller 39 turns on the pump 36, which pumps hot water long enough for it to reach the farthest hot branch pipe 16. After waiting an appropriate amount of time, the person then turns the hot water faucet back on, and, after waiting very briefly for a small amount of residual cold water to drain from the affected hot branch pipe hot water comes out of the faucet. If the person is still using hot water when the pump 36 turns off, hot water bypasses the pump 36 by flowing instead through the flow detector 37 and bypass check valve 38 without encountering any resistance from the pump's impeller. The bypass check valve 38 prevents the defeating of the system by eliminating an otherwise low resistance path from the pump's output back to its input. The “type one fast installation unit” 35 shown in FIG. 2 is designed for a pump with an impeller that remains fully engaged with its drive train and motor when the pump is off, thereby impeding or completely obstructing the flow of water through the turned-off pump.

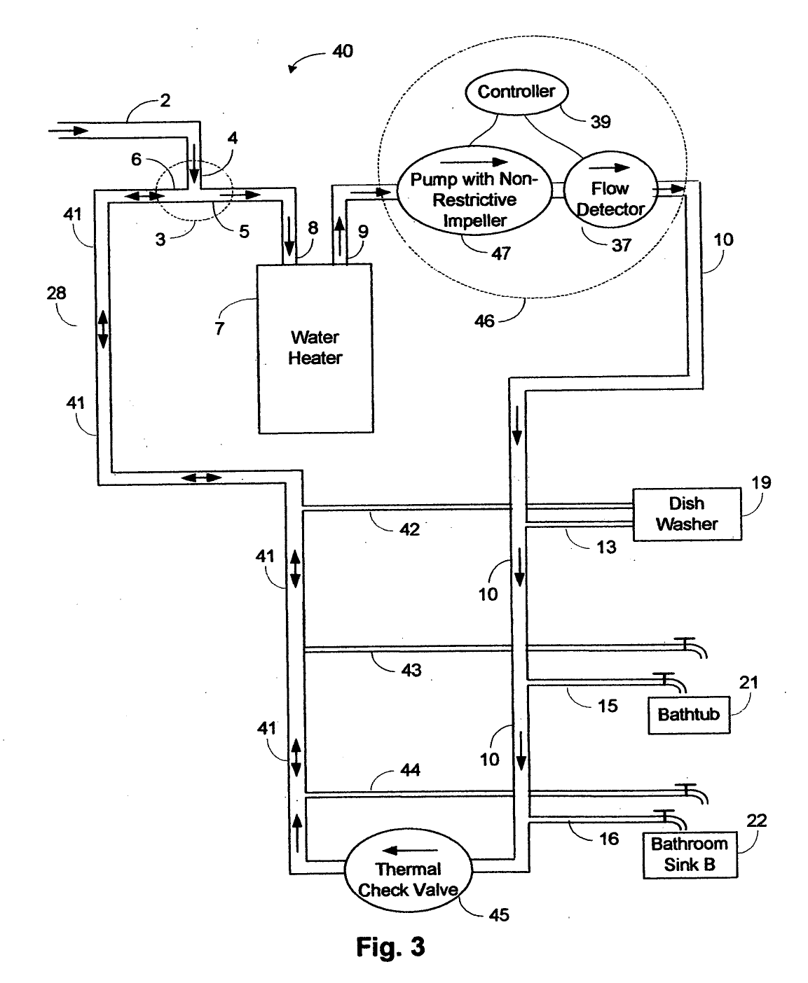

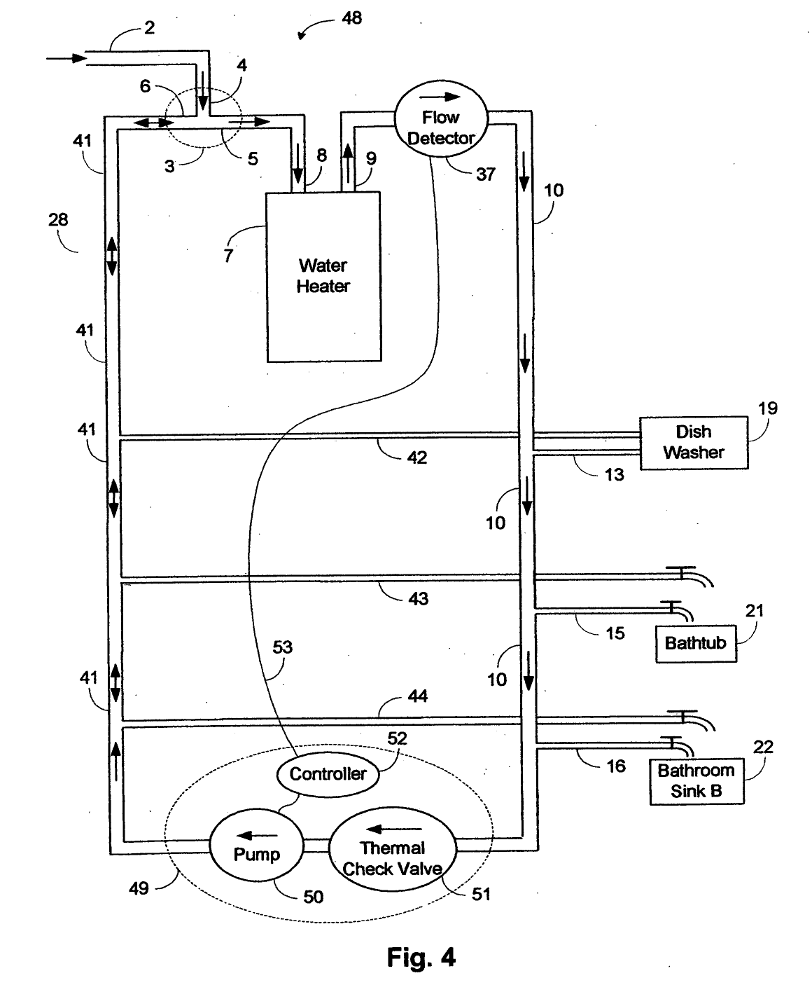

FIG. 3. shows a system 40 in which the cold water pipe and the return pipe are the same pipe 41. That return/cold pipe 41 feeds several cold branch pipes 42-44. (For simplicity in diagramming, FIG. 3 shows only three stations 19, 21 and 22.) The main check valve 28 (not shown in FIG. 3) has been replaced in FIG. 3 by a thermal check valve 45 located between the farthest hot branch pipe 16 and the return pipe 41. Water can flow in both directions within the return/cold pipe 41. When used for cold water distribution, cold water flows in one direction through the return/cold pipe 41—from the main tee pipe 3 to the cold branch pipes 42-44. When used for recirculation of residual cold water from the hot main pipe 10, water flows in the opposite direction through the return/cold pipe 41—from the hot main pipe 10 (via the thermal check valve 45) to the main tee pipe 3. The pump 36 is typically activated when the hot main pipe 10 holds residual cold water, which means that the water on both sides of the thermal check valve 45 is cold. When the water is cold, the thermal check valve 45 permits water to flow from the hot main pipe 10 to the return/cold pipe 41, but not the other way. Thus, residual cold water can flow back to the water heater, but cold water coming directly from the source pipe 2 cannot flow back into the hot main pipe. When the pump 36 is running and hot water reaches the thermal check valve 45, it senses the hot temperature of the water and closes, thereby preventing hot water from reaching the cold branch pipes 42-44. If, at the time of this closure, no hot water faucet is open, it will cause the pump 36 to be unable to pump any water, but the time limit is such that the pump will soon turn off. The “type one fast installation unit” 46 shown in FIG. 3 is designed for a pump with an impeller that is connected to its drive train and motor by means of a mechanism, such as a “Bendix Gear,” that automatically disengages the impeller from the drive train when the motor is turned off, thereby allowing the flow of water through the turned-off pump to spin the impeller with little resistance. This configuration eliminates the need for the bypass check valve 38 as shown in FIG. 2.

FIG. 4. shows a system 48 in which the pump 50, the thermal check valve 51, and the controller 52 are all integrated into a “type two fast installation unit” 49. This configuration requires a long connection between the flow detector 37 and the controller 52, which can be by wire or wireless.

I claim:

1. A hot water distribution system for conserving both water and energy comprising:
a source pipe that supplies unheated water to said system form an external water source;
a main tee pipe, said main tee pipe having three interconnecting ports to which three pipes can be attached and thereby interconnected, said ports being arranged in some shape, such as the shape of the letter “T,” said source pipe being connected to the first port of said main tee pipe;
a water heating means, said means having an inlet and an outlet, said inlet being connected via a pipe to the second port of said main tee pipe;
a hot main pipe, said hot main pipe being connected to said outlet;
a plurality of hot branch pipes, including (without limitation) a nearest branch pipe, said nearest branch pipe being the closest in distance to said water heating means;
a plurality of stations, said stations being connected to said hot main pipe via said hot branch pipes, some said stations being manual stations and the other said stations being automatic stations, said manual stations each including (without limitation) a hot water faucet that a person can operate to turn the flow of hot water on and off, said manual stations including (without limitation) a farthest manual station, said farthest manual station being the farthest in distance from said water heating means, said automatic stations each being an automatic device that draws hot water;
a return pipe, one end of said return pipe being connected to said hot main pipe at a point near said farthest manual station, the other end of said return pipe being connected to the third port of said main tee pipe, said return pipe completing a loop for recirculation of water within said system;
a main check valve to permit water to flow in one direction but not the other, said check valve being positioned on said return pipe and permitting water to flow toward said main tee pipe;
a recirculation means for recirculating water around said loop from said outlet to said inlet of said water heating means, said recirculation means having two recirculation modes, the first said recirculation mode being an active mode, said active mode being a mode wherein water recirculates around said loop, the second said recirculation mode being an inactive mode, said inactive mode being a mode wherein water does not recirculate around said loop;
a detection means for detecting water flow, said detection means being positioned at a point on said hot main pipe that lies between said outlet of said water heating means and said nearest branch pipe, said detection means being sensitive to the flow of water in said hot main pipe at the point where it is positioned, said detection means not being positioned at any point on said source pipe, said detection means not being positioned at any point on said main tee pipe, said detection means not being positioned at any point on said inlet;
a control means for controlling whether said recirculation means is in its active or inactive mode, said control means being connected to said detection means and to said recirculation means, said control means including (without limitation) a count-down timer, a count-down time limit, a time-of-day clock, a plurality of programmed-activation-intervals, two count-down modes, and two programmed-activation modes, said programmed-activation-intervals each consisting of a start time-of-day and a stop time-of-day, the first said count-down mode being a count-down inactive mode, the second said count-down mode being a count-down active mode, the first said programmed-activation mode being a program inactive mode, the second said programmed-activation mode being a program active mode, said control means being, at any time, in exactly one of said count-down modes and also in exactly one of said programmed-activation modes, said control means responding, at any time when in its count-down inactive mode, to the draw of hot water from any of said stations, including (without limitation) the momentary opening and closing of any said hot water faucet, by switching to its count-down active mode and starting said count-down timer, said control means responding, at any time when in its count-down active mode, to said count-down time limit having lapsed on said count-down timer by switching to its count-down inactive mode, said control means responding to the time-of-day clock being, with respect to any of said programmed-activation-intervals, at a time after the start time-of-day and before the stop time-of-day by switching to its program active mode, said control means responding to the time-of-day clock being, with respect to none of said programmed-activation-intervals, at a time after the start time-of-day and before the stop time-of-day by switching to its program inactive mode, said control means causing said recirculation means to be in its active mode whenever said control means is in its count-down active mode, said control means causing said recirculation means to be in its active mode whenever said control means is in its program active mode, said control means causing said recirculation means to be in its inactive mode whenever said control means is in both its count-down active mode and its program inactive mode.

2. The hot water distribution system of claim 1, wherein installation of the recirculation means, the detection means and the control means is simplified, said hot water distribution system further comprising:
type one fast installation unit for easy installation of said recirculation means, said detection means and said control means all in a single, integrated unit, said type one fast installation unit consisting of a unit input port, a unit output port, said recirculation means, said detection means, said control means, and an inoperative impeller bypass means, said type one fast installation unit dividing said hot main pipe into a first portion and a second portion, said first portion of said hot main pipe being connected to said unit input port, said unit output port being connected to second portion of said hot main pipe, hot water thereby being required to flow through said type one fast installation unit in the process of travelling from said outlet to said hot branch pipes, said recirculation means, at any time when in its active mode, causing water to be propelled from said unit input port through said type one fast installation unit to said unit output port, said inoperative impeller bypass means, at any time when said recirculation means is in its inactive mode, permitting water to flow unobstructed from said unit input port through said detection means to said unit output port.

3. The hot water distribution system of claim 2, wherein the detection means and the recirculation means are connected in series, further comprising:
an impeller within said recirculation means to push water from the unit input port to the unit output port,
drive train within said recirculation means to cause said impeller to rotate and thereby push water, said drive train being engaged with said impeller whenever said recirculation means is in its active mode, said inoperative impeller bypass means causing said drive train to be disengaged from said impeller whenever said recirculation means is in its inactive mode thereby permitting said impeller to rotate freely without obstructing the flow of water.

4. The hot water distribution system of claim 2, wherein the detection means and the recirculation means are connected in parallel, further comprising:
a bypass check valve within the type one fast installation unit to permit water to flow in one direction but not the other, said bypass check valve being connected in series with said detection means but in parallel with said recirculation means, said inoperative impeller bypass means thereby providing a path around said recirculation means through which water is permitted to flow without obstruction when said recirculation means is in its inactive mode, said bypass check valve permitting water to flow toward the hot branch pipes.

5. The hot water distribution system of claim 1, wherein existing cold water pipes are used for the return of hot water, said hot water distribution system further comprising:
a cold water distribution means for delivering cold water to the stations so that each station receives both hot water and cold water, said cold water distribution means utilizing the return pipe for delivery of cold water to the stations; water in said return pipe sometimes flowing in one direction for delivery of cold water thereto to said stations, water in said return pipe sometimes flowing in the other direction for the return of hot water to the water heating means;
a plurality of cold branch pipes, each said cold branch pipe connecting said return pipe to one of said stations;
a thermal detection means within the main check valve for controlling the one-way flow of water on the basis of the temperature of the water, said main check valve with its thermal detection means being called a thermal check valve, said thermal check valve having two thermal modes, the first said mode being a cold flow mode, the second said mode being a hot non-flow mode, said thermal check valve having a threshold temperature, said thermal check valve being sensitive to changes in the temperature of the water and switching said modes when the temperature of the water rises above or falls below said threshold temperature, said thermal check valve being in said cold flow mode when the temperature of the water is below said threshold temperature, said thermal check valve being in said hot non-flow mode when the temperature of the water is at or above said threshold temperature, said thermal check valve permitting water to flow in one direction in said cold flow mode, said thermal check valve prohibiting water from flowing in either direction in said cold flow mode, said thermal check valve being positioned on said return pipe between the hot branch pipe leading to the farthest manual station and the cold branch pipe leading to said farthest manual station, said thermal check valve, when in said cold flow mode, permitting water to flow in said return pipe towards the main tee pipe.

6. The hot water distribution system of claim 5, wherein installation of the recirculation means, the detection means and the control means is simplified, said hot water distribution system further comprising:
a type one fast installation unit for easy installation of said recirculation means, said detection means and said control means all in a single, integrated unit, said type one fast installation unit consisting of a unit input port, a unit output port, said recirculation means, said detection means, said control means, and an inoperative impeller bypass means, said type one fast installation unit dividing said hot main pipe into a first portion and a second portion, said first portion of said hot main pipe being connected to said unit input port, said unit output port being connected to second portion of said hot main pipe, hot water thereby being required to flow through said type one fast installation unit in the process of travelling from said outlet to said hot branch pipes, said recirculation means, at any time when in its active mode, causing water to be propelled from said unit input port through said type one fast installation unit to said unit output port, said inoperative impeller bypass means, at any time when said recirculation means is in its inactive mode, permitting water to flow unobstructed from said unit input port through said detection means to said unit output port.

7. The hot water distribution system of claim 5, wherein installation of the recirculation means, the control means and the thermal check valve is simplified, said hot water distribution system further comprising:
a type two fast installation unit for easy installation of said recirculation means, said control means and said thermal check valve all in a single, integrated unit, said type two fast installation unit consisting of a unit input port, a unit output port, said recirculation means, said control means, and said thermal check valve, said type two fast installation unit being positioned on said return pipe between the hot branch pipe leading to the farthest manual station and the cold branch pipe leading said farthest manual station, said type two fast installation unit thereby dividing said return pipe into a first portion and a second portion, said first portion of said return pipe lying on the side of said hot branch pipe leading to the farthest manual station and being connected to said unit input port, said second portion of said return pipe lying on the side of said cold branch pipe leading to the farthest manual station and being connected to said unit output port, said recirculation means, at any time when in its active mode, causing water to be propelled from said unit input port through said type two fast installation unit to said unit output port.

8. The hot water distribution system of claim 7, wherein the control means is connected to the thermal check valve, and, in response to said thermal check valve being in its hot non-flow mode, causes the recirculation means to be in it inactive mode.

9. The hot water distribution system of claim 1, wherein the control means is connected to the detection means and to the recirculation means by wiring.

10. The hot water distribution system of claim 1, wherein the control means is connected to the detection means by a wireless connection.

11. The hot water distribution system of claim 1, wherein the control means is connected to the recirculation means by a wireless connection.

12. The hot water distribution system of claim 1, further comprising:
a user-interface means for a person to adjust the sensitivity of the detection means.

13. The hot water distribution system of claim 1, further comprising:
a user-interface means for a person to set and change the count-down time limit of the control means, and, for each programmed-activation-interval of the control means, to set and change the start time-of-day and the stop time-of-day.

14. The hot water distribution system of claim 5, further comprising:
a user-interface means for a person to adjust the threshold temperature of the thermal check valve.
